(19) United States
(12) Patent Application Publication
(10) Pub. No.: US 2025/0218642 A1
(43) Pub. Date: Jul. 3, 2025

(54) ADJUSTABLE INDUCTOR, AND TRANSMISSION CIRCUIT FOR MAGNETIC RESONANCE

(71) Applicant: WUHAN UNITED IMAGING LIFE SCIENCE INSTRUMENT CO., LTD, Wuhan, Hubei (CN)

(72) Inventors: Youlei Xu, Wuhan, Hubei (CN); Fangyan Hou, Wuhan, Hubei (CN); Yuman Zhang, Wuhan, Hubei (CN)

(21) Appl. No.: 18/851,746

(22) PCT Filed: Apr. 25, 2023
(86) PCT No.: PCT/CN2023/090475

§ 371 Date: Sep. 27, 2024

(30) Foreign Application Priority Data
Apr. 25, 2022 (CN) 202210440570.7

(51) Int. Cl. H01F 21/02; H01F 21/00

(52) U.S. Cl. CPC H01F 21/02; H01F 21/005

(57) ABSTRACT

Disclosed in the present invention is an adjustable inductor, and a transmission circuit for magnetic resonance. The adjustable inductor comprises a fixing assembly, an inductance assembly and a sliding assembly. The inductance assembly is electrically connected to the fixing assembly. The sliding assembly is electrically connected to the fixing assembly and the inductance assembly, and is configured to be able to change the contact position with the inductance assembly so as to change the inductance value of the inductance assembly.

The present application claims priority to Chinese patent application No. 202210440570.7, filed on Apr. 25, 2022, and entitled “ADJUSTABLE INDUCTOR AND TRANSMISSION CIRCUIT FOR MAGNETIC RESONANCE”, the entire content of which is incorporated herein by reference.

### TECHNICAL FIELD

The present disclosure relates to the field of inductor technologies, and in particular, to an adjustable inductor and a transmission circuit for magnetic resonance.

### BACKGROUND

An inductor is a kind of electrical components used to convert electrical energy into stored magnetic energy, and it has a wide range of applications. The main function of the inductor is to isolate and filter an alternating current signal or to form a resonant circuit with a capacitor, a resistor, etc. The structure of the inductor mainly includes a skeleton, an iron core, and an enameled coil wrapped around the iron core. The structure of the inductor is simple, and the inductor is easy to install.

An adjustable inductor is an inductor with an adjustable inductance.

Currently, there is an adjustable inductor to adjust the inductance of the inductor by adjusting the length of the iron core inserted into the iron core, but the adjustable inductor containing the iron core cannot be used for magnetic resonance.

### SUMMARY

An adjustable inductor is provided in the present disclosure. The adjustable inductor includes a fixing assembly; an inductance assembly electrically connected to the fixing assembly; and a sliding assembly electrically connected to the fixing assembly and the inductance assembly. The sliding assembly is configured to change contact position with the inductance assembly to change inductance of the inductance assembly.

In an embodiment, the inductance assembly includes an inductor, the sliding assembly being configured to be slidably connected to the inductor, which causes inductance of the sliding assembly to be changed during a sliding process of the inductance assembly.

In an embodiment, the inductance assembly extends circumferentially along a circumferential direction of the fixing assembly, and the sliding assembly is configured to slide along a circumferential direction of the inductance assembly.

In an embodiment, the inductance assembly includes a substrate. The inductor is formed on the substrate, the substrate is connected to the fixing assembly, and the sliding assembly is slidably connected to the inductor along a circumferential direction of the inductor.

In an embodiment, the inductance assembly further includes a base. The base is connected to the substrate, the base is provided with a first chute corresponding to the inductor, the first chute is arranged along the circumferential direction of the inductor, and the sliding assembly is slidably inserted into the first chute.

In an embodiment, the inductance assembly further includes a connecting part. The connecting part is rotatably connected to the fixing assembly, the sliding assembly is slidably connected to the connecting part, and the sliding assembly is electrically connected to the fixing assembly through the connecting part.

In an embodiment, the sliding assembly is configured to slide along a length direction of the connecting part.

In an embodiment, the adjustable inductor further includes a limiting assembly. The inductor is connectable to the sliding assembly through the limiting assembly.

In an embodiment, the inductance assembly further includes a base. The limiting assembly includes a limiting part and an engaging part. The limiting part is connected to the base along an extension direction of the inductor, and the engaging part is slidably connected to the connecting part along the length direction of the connecting part.

In an embodiment, the limiting assembly further includes a first elastic part. An end of the first elastic part is rotatably connected to the fixing assembly, and another end of the first elastic part is connected to the engaging part such that the engaging part is engaged with the limiting part.

In an embodiment, the limiting part includes a plurality of latching teeth. The plurality of latching teeth is arranged along a circumferential direction of the inductor and spaced apart from each other.

In an embodiment, the inductance assembly further includes a substrate and a base. The base is connected to the substrate, and the base is provided with a first chute corresponding to the inductor. The sliding assembly includes a first sliding part. The first sliding part is slidably connected to the connecting part, is slidably inserted into the first chute, and abuts against the inductor. The sliding part is electrically connected to the connecting part and the inductor respectively.

In an embodiment, the connecting member includes a conductive strip, the conductive strip is rotatably connected to the fixing assembly and is electrically connected to the inductor through the fixing assembly. The first sliding part is slidably connected to the conductive strip and is electrically connected to the conductive strip.

In an embodiment, the connecting member includes a second rolling part. A side of the second rolling part is rollably connected to the conductive strip, and another side of the second rolling part rollably abuts against the base.

In an embodiment, the sliding assembly further includes a second elastic part. The second elastic part is connected to the first sliding part and abuts against the base, which is capable of pushing the first sliding part against the inductor.

In an embodiment, the sliding assembly further includes at least one first rolling part. A side of the first rolling part is rollably connected to the first sliding part, and another side of the first rolling part rollably abuts against the base for rollably supporting the first sliding part.

In an embodiment, the inductance assembly further includes a connecting part. The connecting part is rotatably connected to the fixing assembly, the sliding assembly is slidably connected to the connecting part along the length direction of the connecting part, and the sliding assembly is electrically connected to the fixing assembly through the connecting part, to partially short-circuit the inductor between the sliding assembly and the fixing assembly.

In an embodiment, the adjustable inductor further includes a shielding cover. The shielding cover covers the inductor.

In an embodiment, the shielding cover is provided with a third chute. The third chute is arranged along the circumferential direction of the inductor. The sliding assembly further includes a third sliding part. The third sliding part is slidably inserted into the third chute.

A transmission circuit for magnetic resonance is also provided in the present disclosure, which includes the adjustable inductor according to each of the above embodiments.

A magnetic resonance apparatus is further provided in the present disclosure, which includes the transmission circuit for magnetic resonance as described above.

Details of various embodiments of the present disclosure will be illustrated in the following accompanying drawings and description. Based on the specification, the accompanying drawings, and the claims, other features, problems solved, and technical effects of the present disclosure will be readily understood by those skilled in the art.

### BRIEF DESCRIPTION OF THE DRAWINGS

Reference may be made to one or more of the accompanying drawings for better describing and illustrating embodiments of the present disclosure, but additional details or examples used to describe the accompanying drawings should not be considered as limiting the scope of any of the inventive creations of the present disclosure, the embodiments presently described, or the preferred way.

FIG. 1 is a schematic diagram of a structure of a substrate, an inductance assembly, a base, a sliding assembly, a connecting part, and a limiting assembly according to an embodiment of the present disclosure.

FIG. 2 is a schematic diagram illustrating a configuration of a substrate and an inductance assembly according to an embodiment of the present disclosure.

FIG. 3 is a schematic diagram illustrating a configuration of a substrate, an inductance assembly, and a base according to an embodiment of the present disclosure.

FIG. 4 is a schematic diagram illustrating a configuration of an adjustable inductor according to an embodiment of the present disclosure.

FIG. 5 is a schematic diagram illustrating a configuration of a substrate, a shielding cover and a knob according to an embodiment of the present disclosure.

FIG. 6 is a partially enlarged schematic diagram illustrating a sliding assembly, a connecting part, and a limiting assembly according to an embodiment of the present disclosure.

FIG. 7 is a schematic side view of a fixing assembly, a base, an inductance assembly, a connecting part, and a sliding assembly according to an embodiment of the present disclosure.

FIG. 8 is a partially enlarged schematic diagram illustrating a fixing assembly and a connecting part according to an embodiment of the present disclosure.

FIG. 9 is a partially enlarged schematic diagram illustrating a sliding assembly and a connecting part according to an embodiment of the present disclosure.

FIG. 10 is a schematic circuit diagram illustrating a transmission circuit for magnetic resonance according to an embodiment of the present disclosure.

FIG. 11 is a schematic circuit diagram illustrating a phase modulation circuit according to an embodiment in the present disclosure.

### DETAILED DESCRIPTION OF THE EMBODIMENTS

Preferred embodiments of the present disclosure will be described in detail below with reference to the accompanying drawings. The accompanying drawings constitute a part of the present disclosure and are used together with the embodiments of the present disclosure to illustrate the principles of the present disclosure and are not intended to limit the scope of the present disclosure.

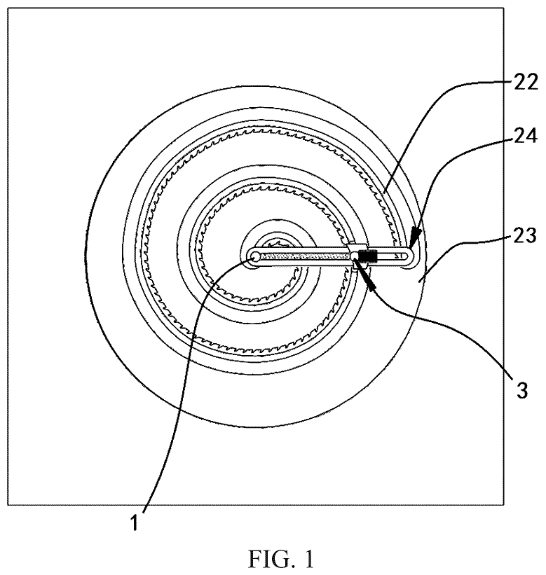

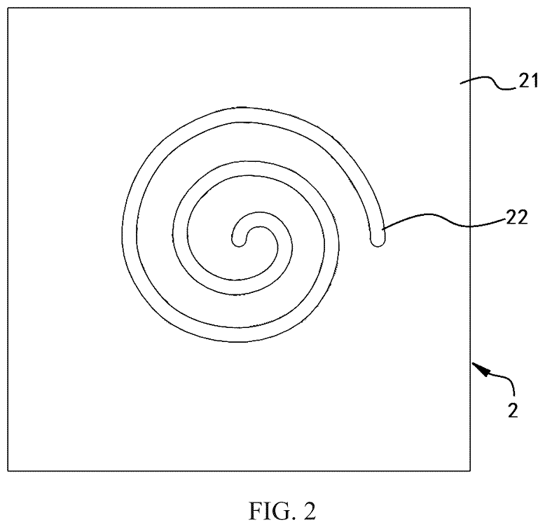

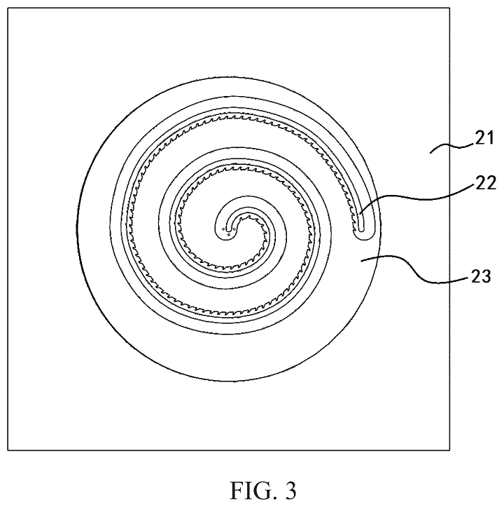

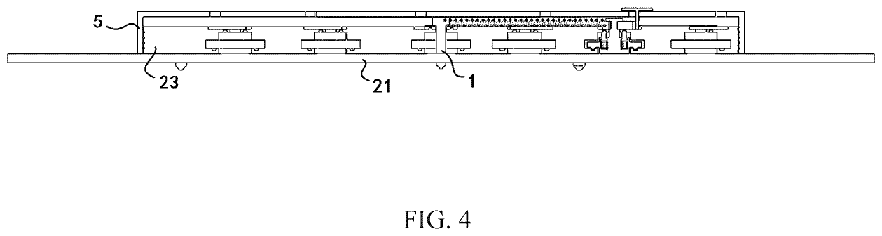

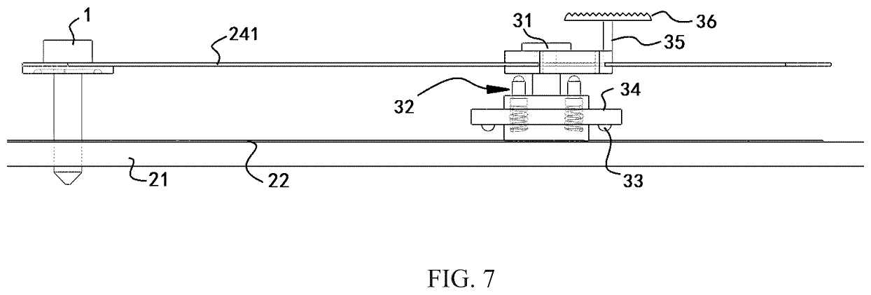

In the present disclosure, an adjustable inductor is provided. The adjustable inductor includes a fixing assembly, an inductance assembly, and a sliding assembly. The inductance assembly is electrically connected to the fixing assembly. The sliding assembly is electrically connected to the fixing assembly and the inductance assembly. The sliding assembly is configured to change contact position with the inductance assembly to change inductance of the inductance assembly. According to the embodiments as shown in FIG. 1, FIG. 2, FIG. 4, and FIG. 7, an adjustable inductor is provided in the present disclosure, including a fixing assembly 1, an inductance assembly 2 and a sliding assembly 3. The inductance assembly 2 includes an inductor 22. The inductor 22 extends circumferentially along a circumferential direction of the fixing assembly 1 and is electrically connected to the fixing assembly 1. The sliding assembly 3 is slidably connected to the inductance assembly 2 and can slide along a circumferential direction of the inductor 22. The sliding assembly 3 is configured to remain electrically connected to the inductor 22 during the sliding process of the sliding assembly 3 along the circumferential direction of the inductor 22. The sliding assembly 3 is electrically connected to the fixing assembly 1 such that the inductance of the inductance assembly 2 is changed during the sliding process of the sliding assembly 3 along the circumferential direction of the inductor 22.

The inductor 22 located between the sliding assembly 3 and the fixing assembly 1 is partially short-circuited. When the inductance of the inductor needs to be adjusted, the sliding assembly 3 is driven to slide along the circumferential direction of the inductor 22, causing the inductance of a part of the inductor 22 located outside of the sliding assembly 3 and the fixing assembly 1 changing, to adjust the inductance of the inductance assembly 2. In some embodiments, the adjustable inductor does not include an iron core, so that the adjustable inductor can be applied to the magnetic resonance.

It can be understood that the fixing assembly 1 may be a rod, a block or the like.

In an embodiment, the fixing assembly 1 is a bolt having a large diameter end and a small diameter end.

In an embodiment, the inductance assembly 2 includes a substrate 21 and an inductor 22 formed on the substrate 21. The substrate 21 is connected to the fixing assembly 1. The inductor 22 extends along the circumferential direction of the fixing assembly 1 and is electrically connected to the fixing assembly 1. The sliding assembly 3 is slidably connected to the inductor 22 along the circumferential direction of the inductor 22, and is electrically connected to the inductor 22 and the fixing assembly 1 respectively.

Since the inductor 22 extends circumferentially along the circumferential direction of the fixing assembly 1, when the sliding assembly inductor 3 slides relative to the substrate 21, the radial displacement of the sliding assembly 3 along the inductor 22 is small, and a plurality of turns of the inductor can be arranged in a smaller space.

It can be understood that the substrate 21 may be made of a high-frequency plate, such as a Rogers plate.

It can be understood that the substrate 21 may be bonded to the small diameter end of the fixing assembly 1 by glue, or may be welded, or screwed to the small diameter end of the fixing assembly 1.

It can be understood that the inductor 22 may be made of a non-ferrous conductor such as copper, silver, or gold.

It can be understood that the shape of the inductor 22 may have a spiral shape, a scroll shape, an arc shape, a circular arc shape, or the like.

Referring to FIG. 9, in an embodiment, the inductance assembly 2 further includes a base 23. The base 23 is connected to the substrate 21. The base 23 is provided with a first chute 23a corresponding to the inductor 22. The first chute 23a is arranged along the circumferential direction of the inductor 22. The sliding assembly 3 is slidably inserted into the first chute 23a. The sliding assembly 3 is slidably connected to the inductor 22.

Since the base 23 is provided with the first chute 23a and the sliding assembly 3 is slidably inserted into the first chute 23a, the sliding assembly 3 is slidably and electrically connected to the inductor 22. The inductance of the adjustable inductor can be adjusted by sliding the sliding assembly 3 relative to the first chute 23a.

It can be understood that the base 23 may be made of an insulating material, which may be insulating plastic, such as PVC, or resin.

In an embodiment, the small diameter end of the base 23 corresponding to the fixing assembly 1 is provided with a fixed hole 23b. The base 23 is sleeved on the small diameter end of the fixing assembly 1 through the fixed hole 23b. The base 23 is arranged between the large diameter end of the fixing assembly 1 and the substrate 21.

Referring in particular to FIG. 1 and FIG. 6, in an embodiment, the inductance assembly 2 further includes a connecting part 24. The connecting part 24 is rotatably connected to the fixing assembly 1. The sliding assembly 3 is slidably connected to the connecting part 24 along the length direction of the connecting part 24. The sliding assembly 3 is electrically connected to the fixing assembly 1 through the connecting part 24.

When the sliding assembly 3 is driven to slide along the circumferential direction of the inductor 22, the sliding assembly 3 slides relative to the inductor 22, and the sliding assembly 3 slides relative to the connecting part 24 while the sliding assembly 3 drives the connecting part 24 to rotate. During the movement of the sliding assembly 3 relative to the inductor 22, the sliding assembly 3 is always connected to the connecting part 24, so that the sliding assembly 3 is always connected to the fixing assembly 1.

It is understood that the application of the connecting part 24 may not depend on the circumferential movement of the sliding assembly 3 relative to the inductor 2. For example, in other embodiments, the sliding assembly 3 is slidably connected to the connecting part 24 and is electrically connected to the fixing assembly 1 through the connecting part 24. When the sliding assembly 3 changes its contact position with the inductance assembly 2 in various other forms, the inductance of the inductance assembly 2 is changed.

It can be understood that the connecting part 24 can be rotatably sleeved on the fixing assembly 1, or can be rotatably connected to the fixing assembly 1 through a bearing, or can be rotatably connected to the fixing assembly 1 through a component such as a pivot pin.

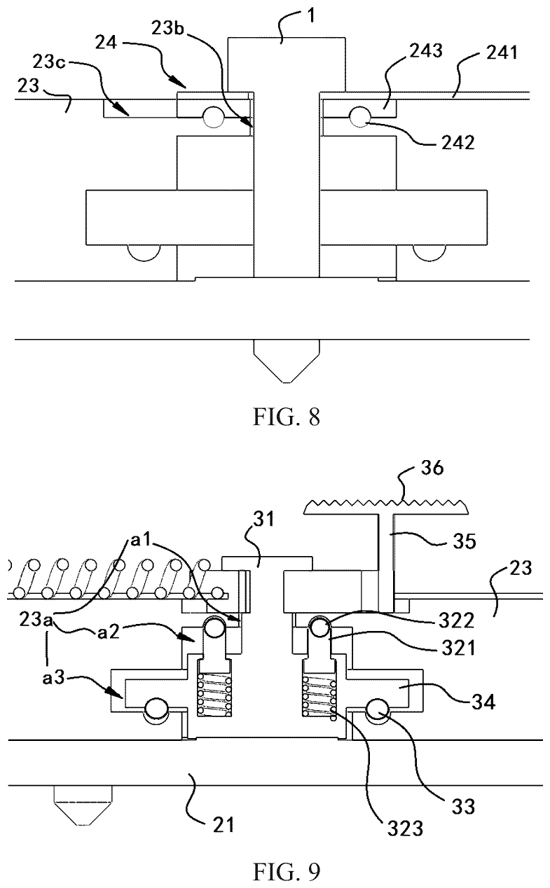

As shown in FIG. 8 and FIG. 9, in an embodiment, the connecting part 24 includes a conductive strip 241, a second rolling part 242, and a rotating part 243. The conductive strip 241 is rotatably connected to the fixing assembly 1 and is electrically connected to the inductor 22 through the fixing assembly 1. A side of the second rolling part 242 is rollably connected to the conductive strip 241 through the rotating part 243, and another side of the second rolling part 242 rollably abuts against the base 23. The sliding assembly 3 includes a first sliding part 31, and the first sliding part 31 is slidably connected to the conductive strip 241 and is electrically connected to the conductive strip 241.

Due to the arrangement of the second rolling part 242, since the conductive strip 241 is arranged between the large diameter end of the fixing assembly 1 and the base 23, and the large diameter end of the fixing assembly 1 presses the conductive strip 241 against the base 23 through the rotating part 243, in the sliding process of the sliding assembly 3, the conductive strip 241 is driven to rotate relative to the fixing assembly 1. The rolling friction of the second rolling part 242 replaces the sliding friction between the conductive strip 241 and the base 23, which can reduce the friction between the conductive strip 241 and the base 23, and facilitate the rotation of the conductive strip 241 relative to the base 23 and the fixing assembly 1.

It can be understood that the conductive strip 241 may be made of a non-ferrous conductor such as copper, silver, gold, etc.

In an embodiment, the base 23 is provided with an annular groove 23c communicating with the fixed hole 23b. The annular groove 23c is arranged coaxially with the fixed hole 23b. Referring to FIG. 6, the conductive strip 241 is provided with a second sliding groove 241a along a length direction. The conductive strip 241 is slidably sleeved on the small diameter end of the fixing assembly 1 through the second slide groove 241a and is arranged between the base 23 and the large diameter end of the fixing assembly 1. The rotating part 243 is sleeved on the small diameter end of the fixing assembly 1 and embedded in the annular groove 23c. An end of the rotating part 243 abuts against the conductive strip 241, and another end of the rotating part 243 is provided with a first fixing groove (not shown) relative to a bottom inner wall of the annular groove 23c. A side of the second rolling part 242 is rollably embedded in the first fixing groove, and another side of the second rolling part 242 rollably abuts against the bottom inner wall of the annular groove 23c.

The conductive strip 241 is sleeved on the small diameter end of the fixing assembly 1, so that the conductive strip 241 is rollably connected to the fixing assembly 1. Due to the arrangement of the rotating part 243 and making a side of the second rolling part 242 embedded in the first fixing groove, the second rolling part 242 is fixed relative to the rotating part 243, to prevent the second rolling part 242 from moving randomly.

It can be understood that the shape of the second rolling part 242 may be spherical or roller-shaped, and the shape of the first fixing groove matches the shape of the side of the second rolling part 242.

As shown in FIG. 6 and FIG. 9, in an embodiment, a side of the first sliding part 31 is slidably connected to the connecting part 24, and another side of the first sliding part 31 is slidably inserted into the first chute 23a to abut against the inductor 22. The first sliding part 31 is electrically connected to the connecting part 24 and the inductor 22 respectively.

The first sliding part 31 is slidably inserted into the first chute 23a of the base 23, so that the first sliding part 31 can slide along the guide of the first chute 23a, and the first sliding part 31 can slide along the extension direction of the inductor 22. The first sliding part 31 always contacts the inductor 22 during the sliding process of the sliding part 31, causing the first sliding part 31 to be slidably connected to the inductor 22 and conduct the inductor 22.

It can be understood that the first sliding part 31 may be slidably inserted into the conductive strip 241, may be slidably sleeved on the conductive strip 241, or may be slidably connected to the conductive strip 241 through a guide rail.

In an embodiment, the first sliding part 31 can slide through the second sliding groove 241a. The first sliding part 31 is slidable through the second sliding groove 241a, so that the first sliding part 31 is slidably connected to the conductive strip 241.

Referring to FIG. 7, in an embodiment, the sliding assembly 3 further includes a second elastic part 32. The second elastic part 32 is connected to the first sliding part 31 and abuts against the base 23, to push the first sliding part 31 to fit the inductor 22.

Since there may be a gap between the first sliding part 31 and the first chute 23a, by arranging the second elastic part 32, the first sliding part 31 can be pushed to abut against the inductor 22 under the action of the elastic force of the second elastic part 32, so that the first sliding part 31 slidably fits the inductor 22, to avoid a gap between the first sliding part 31 and the inductor 22.

Referring to FIG. 9, in an embodiment, the first chute 23a includes a first groove body a1 and a second groove body a2. The second groove body a2 is closer to the substrate 21 than the first groove body a1, and the cross-sectional size of the second groove body a2 is larger than the cross-sectional size of the first tank a1. The first sliding part 31 can be slidably inserted into the first groove body a1 and the second groove body a2. A side of the first sliding part 31 away from the substrate 21 is provided with a mounting hole (not shown), the opening of the mounting hole is arranged relative to the end inner wall of the second groove body a2. The second elastic part 32 includes a push rod 321, a ball 322, and a thrust spring 323. An end of the push rod 321 can be slidably inserted into the mounting hole, another end of the push rod 321 is provided with a second fixed groove (not shown), a side of the ball 322 can be rollably embedded in the second fixed groove, and another side of the ball 322 can rollably abut against the end inner wall of the second groove body a2. A thrust spring 323 is arranged inside the mounting hole. An end of the thrust spring 323 is connected to the inner wall of the mounting hole, and another end of the thrust spring 323 is connected to the push rod 321. The thrust spring 323 is used to push the ball 322 to abut against the end inner wall of the second groove body a2.

The thrust of the thrust spring 323 pushes the ball 322 to fit against the inner wall of the second groove body a2. The thrust will push the first sliding part 31 to slide in a direction close to the substrate 21, so that the first sliding part 31 fits the inductor 22. Due to the ball 322 rollably abutting against the inner wall of the second groove body a2, the friction between the ball 322 and the inner wall of the second groove body a2 is small, which facilitates the first sliding part 31 to slide relative to the second groove body a2 while the first sliding part 31 exerting thrust.

In an embodiment, the sliding assembly 3 further includes at least one first rolling part 33. A side of the first rolling part 33 can be rollably connected to the first sliding part 31, and another side of the first rolling part 33 can rollably abut against the base 23 to rollably support the first sliding part 31.

The second elastic part 32 is adapted to exert an elastic force on the first sliding part 31 to fit the inductor 22. However, when the elastic force drives the first sliding part 31 to fit the inductor 22, the friction resistance between the first sliding part 31 and the inductor 22 will be increased, which will prevent the first sliding part 31 from sliding relative to the inductor 22. In the present disclosure, by arranging the first rolling part 33, the first sliding part 31 is supported by the rollable first rolling part 33, thereby avoiding the elastic force of the second elastic part 32 preventing the first sliding part 31 from sliding relative to the inductor 22.

In an embodiment, the inner wall of the second groove body a2 is provided with a third groove body a3. The third groove body a3 is connected with the second groove body a2. The third groove body a3 is arranged along the extension direction of the inductor 22. The sliding assembly 3 further includes a second sliding part 34. The second sliding part 34 is connected to the first sliding part 31 and is slidably inserted into the third groove body a3. The side of the second sliding part 34 close to the substrate 21 is provided with a third fixing groove (not shown). A side of the first rolling part 33 can be rollably embedded in the third fixing groove, and another side of the first rolling part 33 can abut against the inner wall of the third groove body a3.

When the first sliding part 31 slides, the first sliding part 31 drives the second sliding part 34 to slide. The second elastic part 32 applies an elastic force to the first sliding part 31 to be close to the inductor 22. The first sliding part 31 drives the second sliding part 34 to move. However, due to the existence of the first rolling part 33, the first rolling part 33 is rollably connected to the second sliding part 34 and rollably abuts against the inner wall of the third groove body a3, which can reduce the friction between the first sliding part 31 and the first chute 23a, to facilitate the sliding of the first sliding part 31 relative to the inductor 22.

It can be understood that each of the first sliding part 31 and the second sliding part 34 may be made of various insulating materials, such as insulating plastic, or insulating ceramic.

As shown in FIG. 6, in an embodiment, the adjustable inductor further includes a limiting assembly 4. The inductor 22 is connectable to the sliding assembly 3 through the limiting assembly 4 to limit the sliding assembly 3 from sliding relative to the inductor 22.

By arranging the limiting assembly 4, the sliding assembly 3 can be limited after sliding, and the sliding assembly 3 can be limited from sliding relative to the inductor 22.

It can be understood that the limiting assembly 4 may be a set screw. By threading the set screw to the sliding assembly 3, and rotating the set screw, the set screw presses against the inductor 22 or the base 23, thereby the set screw being fixed relative to the inductor 22. The slid sliding assembly 3 may also be connected to the inductor 22 by snap fastening, thereby the sliding assembly 3 being fixed to the inductor 22.

As shown in FIG. 6, in an embodiment, the limiting assembly 4 includes a limiting part 41, an engaging part 42, and a first elastic part 43. The limiting part 41 is connected to the inductor 22 along the extension direction of the inductor 22. The engaging part 42 is slidably connected to the connecting part 24 along the length direction of the connecting part 24. An end of the first elastic part 43 is rotatably connected to the fixing assembly 1 and another end of the first elastic part 43 is connected to the engaging part 42. The first elastic part 43 is used to drive the engaging part 42 to snap to the limiting part 41.

During the process of the sliding assembly 3 being driven to slide, the sliding assembly 3 drives the engaging part 42 to slide in the direction away from the fixing assembly 1, so that the sliding assembly 3 can slide relative to the inductor 22. When it is necessary to fix the sliding assembly 3 after sliding, the sliding assembly 3 is released. At this time, the elastic force of the first elastic part 43 acts on the sliding assembly 3, driving the sliding assembly 3 to move in a direction close to the fixing assembly 1, and causing the engaging part 42 to be engaged with the limiting part 41, thereby limiting the sliding assembly 3 relative to the inductor 22 and preventing the sliding assembly 3 from sliding relative to the inductor 22.

In an embodiment, the limiting part 41 includes a plurality of latching teeth 411. The latching teeth 411 are fixed on the base 23. The plurality of latching teeth 411 are arranged along a circumferential direction of the inductor 22 and spaced apart from each other.

It can be understood that limiting part 41 may be various components that can play an engaging role, such as a rack, a fastener, a fixture block or the like.

It can be understood that the latch teeth 411 may be used to limit the two-way sliding of the engaging part 42, or may be used to limit the one-way sliding of the engaging part 42, which can be achieved by changing the angle of the latch teeth 411 relative to the engaging part 42.

In an embodiment, the latching teeth 411 extend along a spiral direction of the inductor 22.

By extending the latching teeth 411 along the spiral direction of the inductor 22, the latching teeth 411 can limit the engaging part 42 from sliding in the direction close to the fixing assembly 1, while the engaging part 42 slides along the spiral direction of the inductor 22.

It can be understood that the latch teeth 411 can be arranged on a side of the engaging part 42 away from the fixing assembly 1, or can be arranged on a side of the engaging part 42 close to the fixing assembly 1. When the latch teeth 411 are arranged on the side of the engaging part 42 away from the fixing assembly 1, the first elastic part 43 has an elastic force to push the engaging part 42 to slide in the direction away from the fixing assembly 1. When the latch teeth 411 is arranged on the side of the engaging part 42 close to the fixing assembly 1, the first elastic part 43 has an elastic force to pull the engaging part 42 to slide in the direction close to the fixing assembly 1.

It can be understood that the first elastic part 43 may be a spring, an elastic strip, an elastic rope, or the like.

It can be understood that when the first elastic part 43 is a spring, an end of the spring is bent to form a circular ring and is rotated through the circular ring to be sleeved on the fixing assembly 1. Alternatively, a collar may be rotatably sleeved on the fixing assembly 1, and then an end of the collar is connected to the spring.

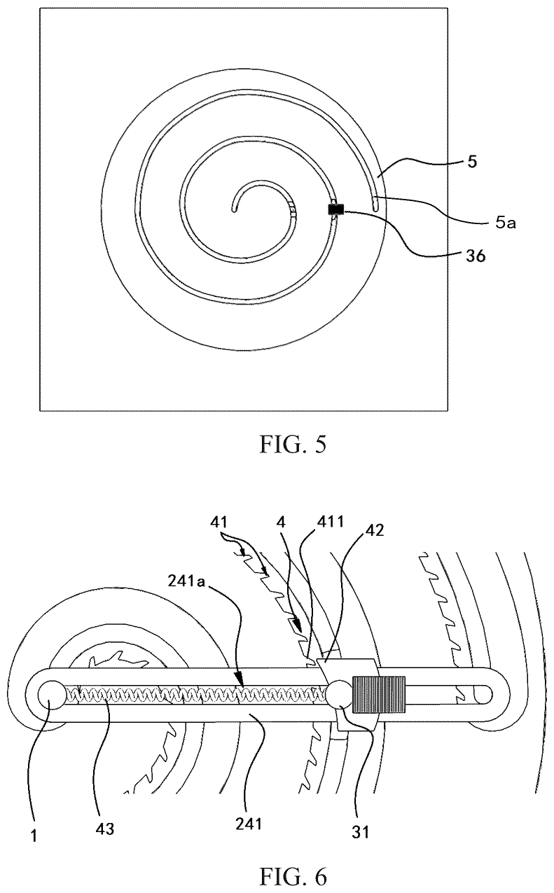

As shown in FIG. 5, in an embodiment, the adjustable inductor further includes a shielding cover 5. The shielding cover 5 covers the inductor 22 and the base 23. The shielding cover 5 is provided with a third chute 5a corresponding to the inductor 22. The third chute 5a is arranged along the circumferential direction of the inductor 22. The sliding assembly 3 further includes a third sliding part 35. The third sliding part 35 is slidably inserted into the third slide groove 5a and connected to the first sliding part 31.

By arranging the shielding cover 5, the shielding cover 5 can perform magnetic shielding, and can also be in contact with the surface of the base 23 to transfer the heat of the internal components of the shielding cover 5 to the outside, thereby facilitating the heat dissipation of the internal components of the shielding cover 5. By arranging the third slider groove 5a and the third sliding part 35, it can guide the sliding of the first sliding part 31.

It can be understood that the third sliding part 35 may be directly connected to the first sliding part 31, or may be connected to the first sliding part 31 through the engaging part 42.

In an embodiment, the sliding assembly 3 further includes a knob 36, which is connected to the third sliding part 35 and is arranged on a side of the shielding cover 5 away from the substrate 21.

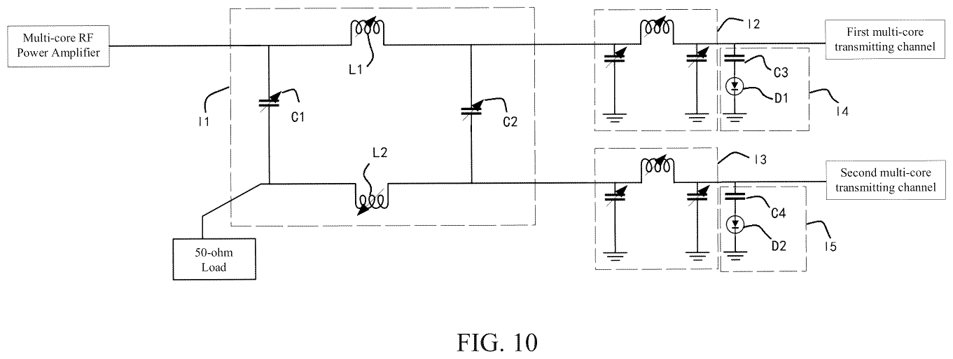

Due to the arrangement of the knob 36, the third sliding part 35 can be driven to slide along the guide of the third slide groove 5a through the knob 36, to facilitate the adjustment of the inductance of the adjustable inductor 22. The present disclosure also relates to a transmission circuit for magnetic resonance. Referring to FIG. 10. The transmission circuit for magnetic resonance includes a 3 db bridge 11, a first phase shift circuit 12, a second phase shift circuit 13, and a first impedance switching circuit 14, and a second impedance switching circuit 15. The 3 db bridge 11 includes an input port, an isolation port, an output port, and a coupling port.

The first impedance switching circuit 14 is connected to the output port through the first phase shift circuit 12.

The second impedance switching circuit 15 is connected to the coupling port through the second phase shift circuit 13.

The 3 db bridge 11, the first phase shift circuit 12, and the second phase shift circuit 13 include the above adjustable inductor.

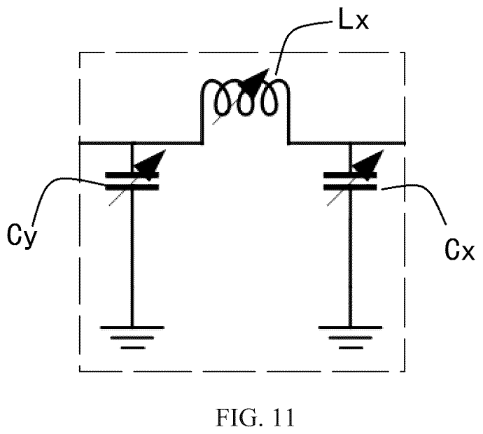

As shown in FIG. 10 and FIG. 11, in an embodiment, the 3 db bridge 11 includes a first adjustable inductor L1, a second adjustable inductor L2, a first tunable capacitor C1, and a second tunable capacitor C2. The first phase shift circuit 12, the first adjustable inductor L1, the first tunable capacitor C1, the second adjustable inductor L2, and the second phase shift circuit 13 are connected in series in sequence. An end of the first tunable capacitor C1 is an input port and the other end is an isolation port. The input port is connected to the radio frequency power amplifier. The isolation port is connected to a 50 ohm load. An end of the first adjustable inductor L1 that is not connected to the first tunable capacitor C1 is an output port. An end of the second adjustable inductor L2 that is not connected to the first tunable capacitor C1 is a coupling port. An end of the first phase shift circuit 12 that is not connected to the first adjustable inductor L1 is a first multi-core transmitting channel. An end of the second phase shift circuit 13 that is not connected to the second adjustable inductor L2 is a second multi-core transmitting channel. An end of the second tunable capacitor C2 is connected to an end of the first adjustable inductor L1 that is not connected to the first tunable capacitor C1. Another end of the second tunable capacitor C2 is connected to an end of the second adjustable inductor L2 that is not connected to the first tunable capacitor C1.

As shown in FIG. 10 and FIG. 11, in an embodiment, the first impedance switching circuit 14 includes a first fixed capacitor C3 and a first diode D1. An end of the first fixed capacitor C3 is connected to the first phase shift circuit 12. The anode of the first diode D1 is connected to another end of the first fixed capacitor C3, and the cathode of the first diode D1 is grounded.

The second impedance switching circuit 15 includes a second fixed capacitor C4 and a second diode D2. An end of the second fixed capacitor C4 is connected to the second phase shift circuit 13, the anode of the second diode D2 is connected to another end second fixed capacitor C4, and the cathode of the second diode D2 is grounded.

The first impedance switching circuit 14 and the second impedance switching circuit 15 are used to switch impedances.

As shown in FIG. 11, the phase shifting circuit includes an adjustable capacitor Cx, an adjustable inductor Lx, and an adjustable capacitor Cy connected in series. An end of the tunable capacitor Cx that is not connected to the adjustable inductor Lx is grounded. An end of the tunable capacitor Cy that is not connected to the adjustable inductor Lx is grounded. An end of the tunable capacitor Cx that is connected to the adjustable inductor Lx and an end of the tunable capacitor Cy that is connected to the adjustable inductor Lx are used as two ends of the phase shift circuit.

In the conventional solution, a signal output from the RFPA (power amplifier) is divided into two signals with a phase difference of 90 degrees through the 3 db bridge 11, and then transmitted to the VTC (Volume Transmitting Coil) for the transmission of 1H nuclide, but the multi-core transmission does not pass through the 3 db bridge 11. Instead, two identical RFPAs are used, one generates a 0-degree transmit signal, and another generates a 90-degree transmit signal. The two signals are passed to the VTC for transmission through two identical paths. During the multi-core transmission, the 3 db bridge 11 of the 1H nuclide is idle and does not play a role. In addition, multiple 3 db bridges 11 can be placed. Different nuclides use different bridges. In actual projects, these bridges are integrated into the inside of the coil. The bridge itself will cause insertion loss. There is a problem of heating during transmission of the bridge, which is not conducive to the design of the coil. The coil has relatively high-temperature requirements. Some designs even need to add a radiator to dissipate heat for the bridge part. The radiator is a metal device. Placing it inside the coil will affect the magnetic field of the magnet or the generation of eddy current fields. The requirements for materials are extremely high.

In the conventional solution, PIN diodes are used as radio frequency switches for multi-nuclide transmission. However, the isolation of PIN diodes under different nuclides varies greatly. The higher the frequency, the lower the isolation. Therefore, it is necessary to purchase higher-performance and more expensive radio frequency switching solutions.

Multi-core transmission requires two RFPAs, which increases the cost of the system. At the same time, since it does not pass through the 3 db bridge 11, the reflected power of the transmission link cannot be consumed by the 50-ohm load. Therefore, a protection circuit, such as an isolator, needs to be added to the output of each RFPA. It also increases the cost of the system.

In the present disclosure, the transmission circuit for magnetic resonance reduces the number of RFPAs and RFPA protection components. The transmitting frequency of the components can be switched based on the nuclide. The way to solve the broadband bridge and broadband switch is through adjustable capacitance and adjustable inductance. By adjusting the capacitance and inductance, it can ensure that the structures of the broadband 3 dB bridge 11 and broadband radio frequency switch are satisfied at different frequencies.

In the present disclosure, a magnetic resonance apparatus is also provided. The magnetic resonance apparatus includes a transmission circuit for magnetic resonance as described in the above embodiments.

The above-mentioned are only preferred specific implementations of the present disclosure, but the protection scope of the present disclosure is not limited thereto. Any changes or substitutions that can be easily thought of by those skilled in the art within the technical scope of the present disclosure should be covered within the protection scope of the disclosure.

What is claimed is:

1. An adjustable inductor, comprising:
a fixing assembly;
an inductance assembly electrically connected to the fixing assembly; and
a sliding assembly electrically connected to the fixing assembly and the inductance assembly, the sliding assembly being configured to change contact position with the inductance assembly to change inductance of the inductance assembly.

2. The adjustable inductor according to claim 1, the inductance assembly comprising an inductor, wherein the sliding assembly is configured to be slidably connected to the inductor such that inductance of the sliding assembly is changed during a sliding process of the inductance assembly.

3. The adjustable inductor according to claim 2, wherein the inductance assembly extends circumferentially along a circumferential direction of the fixing assembly, and the sliding assembly is configured to slide along a circumferential direction of the inductance assembly.

4. The adjustable inductor according to claim 3, the inductance assembly comprising a substrate, wherein the inductor is formed on the substrate, the substrate is connected to the fixing assembly, and the sliding assembly is slidably connected to the inductor along a circumferential direction of the inductor.

5. The adjustable inductor according to claim 4, the inductance assembly further comprising a base, wherein the base is connected to the substrate, the base is provided with a first chute corresponding to the inductor, the first chute is arranged along the circumferential direction of the inductor, and the sliding assembly is slidably inserted into the first chute.

6. The adjustable inductor according to claim 2, the inductance assembly further comprising a connecting part rotatably connected to the fixing assembly, the sliding assembly is slidably connected to the connecting part, and the sliding assembly is electrically connected to the fixing assembly through the connecting part.

7. The adjustable inductor according to claim 6, wherein the sliding assembly is configured to slide along a length direction of the connecting part.

8. The adjustable inductor according to claim 7, further comprising a limiting assembly, wherein the inductor is connectable to the sliding assembly through the limiting assembly.

9. The adjustable inductor according to claim 8, wherein the inductance assembly further comprises a base, the limiting assembly comprises a limiting part and an engaging part, the limiting part is connected to the base along an extension direction of the inductor, and the engaging part is slidably connected to the connecting part along the length direction of the connecting part.

10. The adjustable inductor according to claim 9, wherein the limiting assembly further comprises a first elastic part, an end of the first elastic part is rotatably connected to the fixing assembly, and another end of the first elastic part is connected to the engaging part such that the engaging part is engaged with the limiting part.

11. The adjustable inductor according to claim 9, wherein the limiting part comprises a plurality of latching teeth arranged along a circumferential direction of the inductor.

12. The adjustable inductor according to claim 6, wherein the inductance assembly further comprises a substrate and a base connected to the substrate, the base being provided with a first chute corresponding to the inductor; and
wherein the sliding assembly comprises a first sliding part slidably connected to the connecting part, slidably inserted into the first chute and abutting against the inductor, and the first sliding part is electrically connected to the connecting part and the inductor respectively.

13. The adjustable inductor according to claim 12, wherein the connecting member comprises a conductive strip rotatably connected to the fixing assembly and electrically connected to the inductor through the fixing assembly, and the first sliding part is slidably connected to the conductive strip and is electrically connected to the conductive strip.

14. The adjustable inductor according to claim 13, wherein the connecting member comprises a second rolling part, a side of the second rolling part is rollably connected to the conductive strip, and another side of the second rolling part rollably abuts against the base.

15. The adjustable inductor according to claim 12, wherein the sliding assembly further comprises a second elastic part, and the second elastic part is connected to the first sliding part and abuts against the base for pushing the first sliding part against the inductor.

16. The adjustable inductor according to claim 12, wherein the sliding assembly further comprises at least one first rolling part, a side of the first rolling part is rollably connected to the first sliding part, and another side of the first rolling part rollably abuts against the base for rollably supporting the first sliding part.

17. The adjustable inductor according to claim 3, wherein the inductance assembly further comprises a connecting part rotatably connected to the fixing assembly, the sliding assembly is slidably connected to the connecting part along the length direction of the connecting part, and the sliding assembly is electrically connected to the fixing assembly through the connecting part, to partially short-circuit the inductor between the sliding assembly and the fixing assembly.

18. The adjustable inductor according to claim 3, further comprising a shielding cover covering the inductor;
wherein the shielding cover is provided with a third chute arranged along the circumferential direction of the inductor; and
wherein the sliding assembly further comprises a third sliding part slidably inserted into the third chute.

19. (canceled)

20. A transmission circuit for magnetic resonance, comprising the adjustable inductor of claim 1.

21. A magnetic resonance apparatus, comprising the transmission circuit for magnetic resonance according to claim 20.
